(19) United States
(12) Patent Application Publication
(10) Pub. No.: US 2007/0144233 A1
(43) Pub. Date: Jun. 28, 2007

(54) Flow measurement apparatus and method for checking accuracy of the same

(75) Inventors: Tetsuji Kudo, Kariya-city (JP); Makoto Yamaguchi, Kariya-city (JP); Hiroki Tani, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/453,255

(22) Filed: Jun. 15, 2006

(30) Foreign Application Priority Data
Dec. 9, 2005 (JP) 2005-356111

(51) Int. Cl. G01F 25/00; G01F 1/704; G01F 13/00; G01M 3/18; G01M 3/22

(52) U.S. Cl. 73/1.34; 73/47; 73/49.7; 73/37; 73/40; 73/861; 73/40.7

(57) ABSTRACT

A diaphragm is uniformly and finely deformed by compressed air supplied from an electro-pneumatic regulator, so that test fluid is supplied in conformity with the deformation of the diaphragm. In this way, a flow quantity of the test fluid supplied from a fluid supply device to a measurement passage is accurately adjusted. Therefore, an accuracy of a flow accuracy check device is improved, and a leakage measurement accuracy at the time of measuring a leakage from a fuel injection valve with a flow measurement apparatus is improved. At the time of measuring the leakage from the fuel injection valve, the diaphragm is stopped at a balanced position where a force of the air supplied from the regulator and a resilient force of the diaphragm is balanced. Therefore, a change in a volume of the measurement passage, which would be otherwise caused by movement of the diaphragm, does not occur.

### CROSS REFERENCE TO RELATED APPLICATION

This application is based on and incorporates herein by reference Japanese Patent Application No. 2005-356111 filed on Dec. 9, 2005.

### BACKGROUND OF THE INVENTION

1. Field of the Invention

The present invention relates to a flow measurement apparatus and a method for checking an accuracy of the flow measurement apparatus.

2. Description of Related Art

For example, Japanese Unexamined Patent Publication No. 5-240729, Japanese Unexamined Patent Publication No. 8-43242 and Japanese Unexamined patent Publication No. 2005-172735 (corresponding to US2005/0126278 A1) disclose a flow measurement apparatus, which measures a flow quantity of fluid (an outflow) that leaks from a measurement subject. Particularly, an improvement in the measurement accuracy of the flow quantity of the fluid that leaks from the measurement subject has been demanded. To address such a demand, in Japanese Unexamined Patent Publication No. 2005-172735 (corresponding to US2005/0126278 A1), a small quantity (the minute amount) of fluid leaked from the measurement subject is sensed in the following manner. That is, liquid, which contains an air bubble, is filled in a measurement passage, and this liquid, which contains the air bubble, is moved by the fluid leaked from the measurement subject. The movement of the air bubble is sensed to sense the small quantity of fluid, which leaks from the measurement subject.

When the measurement accuracy of the flow measurement apparatus needs to be improved, a master, which serves as a reference of the measurement accuracy, should have a high accuracy. Previously, a micro-syringe or a fine glass tube is used to supply a predetermined quantity of fluid to the flow measurement apparatus and thereby to set the reference of the measurement accuracy. However, in the case of using the micro-syringe or the glass tube, a volume of the micro-syringe or of the glass tube and/or leakage of the fluid from the micro-syringe or of the glass tube could serve as a factor that causes an error in the measurement accuracy. Therefore, in the case where the leakage of the fluid from the measurement subject is measured, the micro-syringe or the glass tube needs to be disconnected from a measurement circuit of the flow measurement apparatus. Therefore, after checking the measurement accuracy, a relatively long time period is required before starting the measuring operation for measuring the quantity of the fluid leaked from the measurement subject, so that the measuring operation cannot be performed quickly, thereby resulting in a relatively long process time.

Furthermore, in the case of the micro-syringe, a piston is slid relative to a cylinder, so that each of the piston and the cylinder includes a corresponding sliding part, which slides relative to the sliding part of the other one of the piston and the cylinder. Therefore, due to deterioration of the sliding parts of the piston and of the cylinder caused by aging, the flow quantity of the fluid, which serves as the reference, will change with time. As a result, long term stability of the measurement accuracy is not good.

Furthermore, the micro-syringe and the glass tube will become foul after long term use of them, so that the flow quantity of the fluid, which serves as the reference, will change. Therefore, a cleaning mechanism, such as a mechanism for supplying gas for the cleaning purpose recited in Japanese Unexamined Patent Publication No. 5-240729, needs to be provided, thereby resulting in the increased complexity of the flow measurement apparatus.

Furthermore, Japanese Unexamined Patent Publication No. 8-43242 discloses the technique for supplying a predetermined quantity of fluid through use of a diaphragm. However, it is difficult to know an exact deforming speed of the diaphragm, and thereby the flow quantity of fluid cannot be accurately set. As a result, this technique cannot be appropriately used to sense the small flow quantity (the minute amount) of fluid. Furthermore, in Japanese Unexamined Patent Publication No. 8-43242, the amount of deformation of the diaphragm is not controlled, so that it is difficult to finely change the flow quantity of supplied fluid.

### SUMMARY OF THE INVENTION

The present invention addresses the above disadvantages. Thus, it is an objective of the present invention to provide a flow measurement apparatus, which enables achievement of an improved process time, an improved durability and/or an improved measurement accuracy. Furthermore, it is another objective of the present invention to provide a method for checking an accuracy of a flow measurement apparatus in a way that achieves an improved durability and/or an improved measurement accuracy of the flow measurement apparatus.

To achieve the first objective of the present invention, there is provided a flow measurement apparatus that measures an outflow from a measurement subject and includes at least one passage member, a fluid supply means, a deformation sensing means, a computing means and a drive means. The at least one passage member forms a measurement passage and a supply passage connected to each other. The measurement passage is filled with test fluid, which is movable in the measurement passage in response to the outflow from the measurement subject. The fluid supply means includes a resiliently deformable diaphragm and is for supplying the test fluid to the measurement passage through the supply passage upon deformation of the diaphragm, which causes a change in a volume of a space located adjacent to the diaphragm on a measurement passage side of the diaphragm. The deformation sensing means is for sensing an amount of deformation of the diaphragm. The computing means is for computing a flow quantity of the test fluid, which is supplied to the measurement passage by the fluid supply means through the supply passage, based on the amount of deformation of the diaphragm sensed by the deformation sensing means. The drive means is for driving the diaphragm to cause the deformation of the diaphragm.

To achieve the second objective of the present invention, there is provided a method for checking an accuracy of a flow measurement apparatus that measures an outflow from a measurement subject. According to the method, a diaphragm is deformed, so that test fluid is supplied to a measurement passage in conformity with an amount of deformation of the diaphragm. A flow quantity of the test fluid, which is supplied to the measurement passage, is computed based on the amount of deformation of the diaphragm. An amount of movement of the test fluid, which is moved in the measurement passage by the supplying of the test fluid to the measurement passage, is sensed. The accuracy of the flow measurement apparatus is checked based on the flow quantity of the test fluid, which is obtained in the computing of the flow quantity of the test fluid, and the amount of movement of the test fluid, which is sensed in the sensing of the amount of movement of the test fluid.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a fluid supply device of a flow measurement apparatus according to an embodiment of the present invention; and

FIG. 2 is a schematic diagram partially showing the flow measurement apparatus of the embodiment.

### DETAILED DESCRIPTION OF THE INVENTION

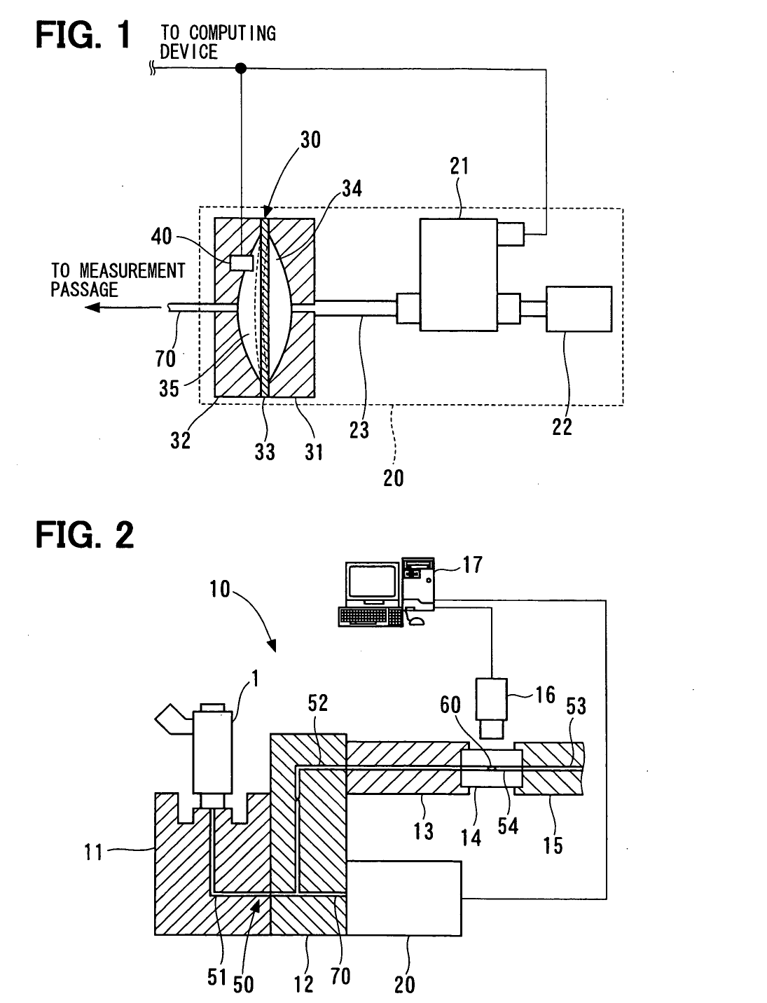

An embodiment of the present invention will be described with reference to FIGS. 1 and 2.

With reference to FIG. 2, a fuel injection valve 1, which serves as a measurement subject, is used in, for example, a gasoline engine (an internal combustion engine). A flow measurement apparatus 10 according to an embodiment of the present invention measures a leakage quantity of fluid, more specifically fuel (an outflow) leaked from a valve seat of the fuel injection valve 1 when the fuel injection valve 1 is in a valve closed state where a needle or a valve body is seated against the valve seat.

The flow measurement apparatus 10 includes passage members 11-15, a camera 16, a flow accuracy check device 20 and a computing device 17.

The passage members 11-15 cooperate together to form a measurement passage 50. The measurement passage 50 includes measurement passage segments 51-53. The measurement passage segment 51 is formed in the passage member 11. The measurement passage segment 52 is located on a fuel injection valve 1 side of an air bubble 60 and is formed by the passage members 12 and 13. The measurement passage segment 53 is located on an opposite side of the air bubble 60, which is opposite from the fuel injection valve 1, and is formed by the passage member 15. The passage member 14 is made of an optically transparent material and forms a measurement passage segment 54, which connects between the measurement passage segment 52 and the measurement passage segment 53. The measurement passage 50 is filled with test fluid, which is used to measure the quantity of fluid leaked from the fuel injection valve 1. The test fluid may be, for example, liquid, such as water or oil. In a case where the measurement of the leakage through use of the air bubble 60 is not carried out, gas, such as air, may be used as the test fluid. The fuel injection valve 1 is connected to the passage member 11, which forms one end of the measurement passage 50, through, for example, a clamp (not shown). Each connection of the respective members is sealed to limit leakage of the test fluid after installation of the fuel injection valve 1.

The passage member 14 is made of the optically transparent material, such as glass or acrylic resin. The measurement passage segment 54, which is formed by the passage member 14, receives the air bubble 60, which is formed in the test fluid filled in the measurement passage segment 54. A cross sectional shape of the measurement passage segment 54 is generally circular. A passage inner diameter of the measurement passage segment 54 is desirably set to a size (desirably equal to or less than 1 mm) that limits floating of the air bubble 60 away from a bottom part of the measurement passage segment 54 in FIG. 2. A minimum value of the inner passage diameter of the measurement passage segment 54 is determined based on a minimum value of the passage inner diameter that is required to allow movement of the air bubble 60 in the measurement passage segment 54. In some cases, the passage inner diameter of the measurement passage segment 54 may be few micrometers, which still allows movement of the air bubble 60 in the measurement passage segment 54, as long as the measurement passage segment 54 can be processed.

The camera 16 is positioned radially outward of the passage member 14. The camera 16 captures an image that shows movement of the air bubble 60 in the measurement passage segment 54, which is formed by the passage member 14. The passage member 14 is made of the optically transparent material, as discussed above. Thus, the camera 16 captures an image of the air bubble 60 in the measurement passage segment 54, which is formed by the passage member 14, though a wall of the passage member 14. The camera 16 is connected to the computing device 17. The image, which is captured by the camera 16, is outputted to the computing device 17 as electronic data. Here, the camera 16 and the computing device 17 constitute an outflow sensing means.

In a case where the fluid leakage occurs at the seat of the fuel injection valve 1, when the fluid is supplied from a fluid supply apparatus (not shown) to the fuel injection valve 1, the test fluid, which is received in the measurement passage 50, is moved by the fluid leaked from the fuel injection valve 1 into the measurement passage 50. In this way, the air bubble 60, which is filled in the test fluid, is moved in the measurement passage segment 54. Leakage of a small quantity of fluid from the seat of the fuel injection valve 1 is measured by measuring an amount of movement of the air bubble 60.

The passage member 12 forms the measurement passage segment 52 and also a supply passage 70, which is branched from the measurement passage segment 52. The supply passage 70 is branched from the measurement passage 50 and is communicated with the flow accuracy check device 20. The flow accuracy check device 20 supplies a reference flow quantity of the test fluid, which serves as a reference at the time of determining the accuracy of the flow measurement apparatus 10, to the measurement passage 50.

As shown in FIG. 1, the flow accuracy check device 20 includes an electro-pneumatic regulator 21 (serving as a drive means) and a fluid supply device 30 (a fluid supply means). The electro-pneumatic regulator 21 adjusts a pressure of compressed air, which is supplied from a supply source 22 to the fluid supply device 30. The electro-pneumatic regulator 21 is connected to the computing device 17. The computing device 17 may be, for example, a personal computer that is driven based on a predetermined software(s). The computing device 17 outputs an electric signal (an electric command) to the electro-pneumatic regulator 21. The electro-pneumatic regulator 21 controls the pressure of the compressed air, which is supplied from the supply source 22 to the fluid supply device 30, according to the electric signal outputted from the computing device 17. The supply source 22 may include, for example, a compressor that compresses the air.

The fluid supply device 30 includes main container sub-parts 31, 32 and a diaphragm 33. The main container sub-parts 31, 32 cooperate together to form a main container. The diaphragm 33 is received in a space, which is formed by the main container sub-parts 31, 32. The diaphragm 33 is made of metal and is shaped into a plate form. With the above construction, the diaphragm 33 is resiliently deformable in the interior of the main container, which is formed by the main container sub-parts 31, 32.

The space, which is formed by the main container sub-parts 31, 32, is divided into an electro-pneumatic regulator 21 side space 34 and a measurement passage 50 side space 35 by the diaphragm 33. The electro-pneumatic regulator 21 side space 34 is communicated with the electro-pneumatic regulator 21 through a connection passage 23, which connects between the electro-pneumatic regulator 21 and the fluid supply device 30. In this way, the compressed air, the pressure of which is adjusted by the electro-pneumatic regulator 21, is supplied to the space 34 of the fluid supply device 30.

The measurement passage 50 side space 35 is communicated with the measurement passage 50 through the supply passage 70. When the compressed air is supplied from the electro-pneumatic regulator 21 to the space 34, the diaphragm 33 is deformed by the pressure of the compressed air. At this time, the compressed air urges the diaphragm 33 toward the space 35 side. Thus, the diaphragm 33 is deformed toward the space 35 side. When the diaphragm 33 is deformed, a volume of the space 35 is reduced. The space 35 is communicated with the measurement passage 50 and is thereby filled with the test fluid. Therefore, when the diaphragm 33 is deformed by the compressed air, which is supplied to the space 34, the corresponding quantity of the test fluid, which corresponds to a change in the volume of the space 35, is supplied to the measurement passage 50 through the supply passage 70.

The flow accuracy check device 20 includes an electrostatic sensor 40, which serves as a deformation sensing means for sensing an amount of deformation of the diaphragm 33. The electrostatic sensor 40 senses a change in a capacitance of the diaphragm 33. By sensing the change in the capacitance of the diaphragm 33, the electrostatic sensor 40 senses a change in a distance from the electrostatic sensor 40 to the diaphragm 33, i.e., senses an amount of deformation of the diaphragm 33 without contacting the diaphragm 33. Therefore, the deformation of the diaphragm 33 is not disturbed by the contact between the electrostatic sensor 40 and the diaphragm 33.

The electrostatic sensor 40 is connected to the computing device 17, which serves as a computing means. The electrostatic sensor 40 senses the change in the capacitance caused by the deformation of the diaphragm 33, and the electrostatic sensor 40 outputs the sensed change in the capacitance to the computing device 17 as corresponding electronic data. The computing device 17 stores previously prepared information about relationship between the amount of deformation of the diaphragm 33 (i.e., the change in the capacitance) and the flow quantity of the test fluid, which is supplied to the measurement passage 50. This information about the relationship may be stored in the computing device 17 in a form of, for example, a map. In this way, the computing device 17 computes the flow quantity of the test fluid, which is supplied to the measurement passage 50, based on the measured change in the capacitance of the diaphragm 33 measured by the electrostatic sensor 40 in view of the above relationship (the map). Then, the computing device 17 determines whether the relationship between the amount of movement of the air bubble 60 in the flow measurement apparatus 10 and the flow quantity of the test fluid, which is supplied from the fluid supply device 30 to the measurement passage 50, is within a predetermined allowable range. This determination is made based on the flow quantity of the test fluid computed above and the amount of movement of the air bubble 60 determined based on the image captured by the camera 16.

Next, a procedure for checking an accuracy of the flow measurement apparatus 10 will be described.

(1) The computing device 17 outputs a preset signal to the electro-pneumatic regulator 21. At this time, the signal, which is outputted from the computing device 17 to the electro-pneumatic regulator 21, indicates the pressure of the compressed air, which needs to be supplied from the electro-pneumatic regulator 21 to the fluid supply device 30.

(2) The electro-pneumatic regulator 21 supplies the compressed air to the fluid supply device 30 based on the signal, which is outputted from the computing device 17. At this time, the electro-pneumatic regulator 21 adjusts the constant pressure of the compressed air, which is supplied from the supply source 22, and supplies the adjusted air, which has the pressure instructed from the computing device 17, to the fluid supply device 30.

(3) When the compressed air is supplied from the electro-pneumatic regulator 21 to the fluid supply device 30, the pressure in the space 34 is increased, and the air supplied to the space 34 urges the diaphragm 33 toward the space 35 side. In this way, the diaphragm 33 is deformed toward the space 35 side, as indicated by a dotted line in FIG. 1. At this time, the space 34, which is located on the electro-pneumatic regulator 21 side of the diaphragm 33, is filled with the air of the predetermined pressure, which is supplied from the electro-pneumatic regulator 21. Thus, the force is uniformly applied to the diaphragm 33 from the air in the space 34. As a result, the diaphragm 33 is generally uniformly deformed.

(4) When the diaphragm 33 is deformed, the test fluid, which is filled in the space 35, is pushed by the diaphragm 33 toward the measurement passage 50 through the supply passage 70. At this time, the electrostatic sensor 40 senses the corresponding capacitance, which corresponds to the amount of deformation of the diaphragm 33, and the electrostatic sensor 40 outputs the sensed capacitance to the computing device 17 as the electronic data.

(5) The test fluid, which is pushed out of the space 35 into the supply passage 70 by the diaphragm 33, is supplied to the measurement passage 50. When the test fluid is supplied to the measurement passage 50, the fluid in the measurement passage 50 begins to flow. Therefore, the air bubble 60 in the measurement passage segment 54 formed by the passage member 14 is moved in the interior of the measurement passage segment 54 due to the flow of the test fluid.

(6) The camera 16 captures the image indicating the movement of the air bubble 60 in the measurement passage 50 and outputs the captured image to the computing device 17 as the electronic data. The computing device 17 computes the amount of deformation of the diaphragm 33 based on the change in the capacitance of the diaphragm 33 outputted from the electrostatic sensor 40. Furthermore, the computing device 17 computes the flow quantity of the test fluid based on the amount of movement of the air bubble 60, the image of which is captured by the camera 16.

(7) The computing device 17 compares the computed amount of deformation of the diaphragm 33 with the flow quantity of the test fluid, which is computed based on the image data captured by the camera 16. Then, the computing device 17 determines whether a relative value, which indicates the corresponding relationship between the amount of deformation of the diaphragm 33 and the flow quantity of the test fluid, is within the predetermined range. When the result of the above determination indicates that the value is within the predetermined range, the accuracy of the flow measurement apparatus 10 is sufficient. In contrast, when the result of the above determination indicates that the value is out of the predetermined range, the accuracy of the flow measurement apparatus 10 is not sufficient. At this time, when the accuracy of the flow measurement apparatus 10 is sufficient, the operation is shifted to the measuring operation of the fuel injection valve 1, which serves as the measurement subject, to measure the leakage from the fuel injection valve 1. In contrast, when the accuracy of the flow measurement apparatus 10 is not sufficient, the computing device 17 may compute a correction value based on the computed amount of deformation of the diaphragm 33 and the computed flow quantity of the test fluid. Then, the computing device 17 may determine the leakage from the fuel injection valve 1 through use of the correction value.

(8) When the operation is shifted to the measurement operation of the fuel injection valve 1, the test fluid is supplied from the fluid supply apparatus (not shown) to the fuel injection valve 1. When the leakage exists at the seat of the fuel injection valve 1, the test fluid, which is filled in the measurement passage 50, is moved. At this time, the air bubble 60 is moved according to the movement of the test fluid. The camera 16 captures the image indicating the movement of the air bubble 60 in the measurement passage segment 54 and outputs the captured image to the computing device 17 as the electronic data. The computing device 17 computes the leakage quantity of the fluid from the fuel injection valve 1 based on the amount of movement of the air bubble 60.

At the time of the measurement operation of the fuel injection valve 1, the electro-pneumatic regulator 21 maintains the constant pressure of the compressed air, which is supplied to the fluid supply device 30. In a case where the pressure of the compressed air, which is supplied from the electro-pneumatic regulator 21 to the fluid supply device 30, is sufficiently large in comparison to the pressure in the supply passage 70, the diaphragm 33 stops at a position where a resilient force of the diaphragm 33 is balanced with the force received from the compressed air in the connection passage 23. In a case where the resilient force of the diaphragm 33 is sufficiently larger than the force applied by the pressure of the test fluid in the supply passage 70, i.e., the diaphragm 33 is sufficiently hard, the diaphragm 33 returns to and stops at its neutral position due to the resilient force of the diaphragm 33 even when the compressed air is not supplied from the electro-pneumatic regulator 21 to the fluid supply device 30.

As described above, according to the embodiment of the present invention, at the time of measuring the leakage from the fuel injection valve 1, the diaphragm 33 stops its movement. Therefore, at the time of measuring the leakage from the fuel injection valve 1, a change in the volume of the measurement passage 50 caused by movement of the diaphragm 33 does not occur. Furthermore, in the fluid supply device 30, the diaphragm 33 is clamped between the main container sub-parts 31, 32, so that the test fluid, which is filled in the supply passage 70 and the space 35, is not leaked. Therefore, at the time of measuring the leakage from the fuel injection valve 1, it is not required to disconnect the flow accuracy check device 20 from the measurement passage 50. Thus, the checking of the accuracy of the flow measurement apparatus 10 and the measuring of the leakage from the fuel injection valve 1 can be continuously performed one after the other, and thus the measurement operation can be quickly performed, thereby resulting in a reduced process time.

Furthermore, according to the embodiment of the present invention, the diaphragm 33 of the fluid supply device 30 is uniformly deformed by the compressed air, which is supplied from the electro-pneumatic regulator 21, and the corresponding flow quantity of the test fluid, which corresponds to this deformation of the diaphragm 33, is supplied to the measurement passage 50. The amount of deformation of the diaphragm 33 is sensed by the electrostatic sensor 40 without contacting the diaphragm 33. In this way, the flow quantity of the test fluid, which is supplied to the measurement passage 50, is directly computed based on the deformation of the diaphragm 33. The diaphragm 33 is deformed by the electro-pneumatic regulator 21, so that fine deformation of the diaphragm 33 is made possible, and thereby the fine adjustment of the test fluid supplied to the measurement passage 50 is made possible. As a result, a small quantity (a minute amount) of the test fluid, which is supplied to the measurement passage 50, can be highly accurately controlled, and the flow quantity of the test fluid, which is supplied to the measurement passage 50, can be highly accurately sensed. Therefore, the accuracy of the flow accuracy check device 20 can be improved, and the measurement accuracy of the leakage from the fuel injection valve 1 can be improved.

Furthermore, according to the embodiment of the present invention, the test fluid is supplied to the measurement passage 50 due to the deformation of the diaphragm 33. Thus, the flow accuracy check device 20 has no sliding portion, and the flow quantity of the test fluid, which is supplied from the flow accuracy check device 20 to the measurement passage 50, does not substantially change with time. Therefore, the durability of the flow measurement apparatus 10 can be improved.

Now, modifications of the above embodiment will be described.

In the above embodiment, the electro-pneumatic regulator 21 is used as the drive means for driving the diaphragm 33. However, the drive means is not limited to the electro-pneumatic regulator 21. For example, in place of the electro-pneumatic regulator 21, it is possible to use a mechanism, which mechanically deforms the diaphragm 33 by directly pushing the diaphragm 33 with a corresponding member. Furthermore, in the above embodiment, the position of the air bubble 60 is sensed through use of the camera 16. In place of the camera 16, the position of the air bubble 60 may be sensed through a laser displacement meter or through visual observation.

Furthermore, the deformation sensing means for sensing the diaphragm 33 is not limited to the electrostatic sensor 40 of the non-contacting type. For example, the deformation sensing means may be a sensor, which senses the deformation of the diaphragm 33 through contact with the diaphragm 33. Furthermore, in the above embodiment, the measurement passage 50 is formed by the passage members 11-15. However, the construction of the passage members, which form the measurement passage 50, can be freely changed in terms of, for example, the number and configuration of the passage members.

Additional advantages and modifications will readily occur to those skilled in the art. The invention in its broader terms is therefore not limited to the specific details, representative apparatus, and illustrative examples shown and described.

What is claimed is:

1. A flow measurement apparatus that measures an outflow from a measurement subject, the flow measurement apparatus comprising:
at least one passage member that forms a measurement passage and a supply passage connected to each other, wherein the measurement passage is filled with test fluid, which is movable in the measurement passage in response to the outflow from the measurement subject;
a fluid supply means that includes a resiliently deformable diaphragm and is for supplying the test fluid to the measurement passage through the supply passage upon deformation of the diaphragm, which causes a change in a volume of a space located adjacent to the diaphragm on a measurement passage side of the diaphragm;
a deformation sensing means for sensing an amount of deformation of the diaphragm;
a computing means for computing a flow quantity of the test fluid, which is supplied to the measurement passage by the fluid supply means through the supply passage, based on the amount of deformation of the diaphragm sensed by the deformation sensing means; and
a drive means for driving the diaphragm to cause the deformation of the diaphragm.

2. The flow measurement apparatus according to claim 1, wherein the deformation sensing means senses the amount of deformation of the diaphragm without contacting the diaphragm.

3. The flow measurement apparatus according to claim 2, wherein:
the diaphragm is made of metal; and
the deformation sensing means is an electrostatic sensor, which senses a capacitance.

4. The flow measurement apparatus according to claim 1, wherein the drive means is an electro-pneumatic regulator, which changes a pressure of air applied to the diaphragm based on an electric command.

5. The flow measurement apparatus according to claim 1, further comprising an outflow sensing means for sensing the outflow from the measurement subject.

6. The flow measurement apparatus according to claim 5, wherein:
a portion of the at least one passage member is made of an optically transparent material, which defines a portion of the measurement passage therein;
the test fluid, which is filled in the portion of the measurement passage, contains an air bubble; and
the outflow sensing means senses movement of the air bubble, which is caused by movement of the test fluid induced by the outflow from the measurement subject, to sense the outflow from the measurement subject.

7. The flow measurement apparatus according to claim 6, wherein the outflow sensing means includes a camera, which captures an image of the air bubble.

8. A method for checking an accuracy of a flow measurement apparatus that measures an outflow from a measurement subject, the method comprising:
deforming a diaphragm and thereby supplying test fluid to a measurement passage in conformity with an amount of deformation of the diaphragm;
computing a flow quantity of the test fluid, which is supplied to the measurement passage, based on the amount of deformation of the diaphragm;
sensing an amount of movement of the test fluid, which is moved in the measurement passage by the supplying of the test fluid to the measurement passage; and
checking the accuracy of the flow measurement apparatus based on:
the flow quantity of the test fluid, which is obtained in the computing of the flow quantity of the test fluid; and
the amount of movement of the test fluid, which is sensed in the sensing of the amount of movement of the test fluid.

9. The method according to claim 8, further comprising measuring the amount of deformation of the diaphragm without contacting the diaphragm before the computing of the flow quantity of the test fluid.

10. The method according to claim 9, wherein the measuring of the amount of deformation of the diaphragm includes sensing a capacitance of the diaphragm, which is made of metal, to determine the amount of deformation of the diaphragm.

11. The method according to claim 8, wherein the deforming of the diaphragm includes deforming of the diaphragm by a pressure of air.
